(19) United States
(12) Patent Application Publication
(10) Pub. No.: US 2005/0078014 A1
(43) Pub. Date: Apr. 14, 2005

(54) Method for signaling a stop request at a request stop

(76) Inventor: Klaus Rapf, Wien (AT)

Correspondence Address: HENRY M FEIEREISEN, LLC, 350 FIFTH AVENUE, SUITE 4714, NEW YORK, NY, 10118, US

(21) Appl. No.: 10/501,257

(22) PCT Filed: Dec. 19, 2002
(86) PCT No.: PCT/AT02/00359

(30) Foreign Application Priority Data
Jan. 9, 2002 (AT) A 28/2002

(51) Int. Cl. G08G 1/123

(52) U.S. Cl. 340/994

(57) ABSTRACT

The invention relates to a signalling method, in particular for signalling a stop request at a request stop (1) of a transport company route, preferably a bus transport company, whereby the request stop (1) is only approached if a passenger wishes to board or alight. According to said method: the stop request is entered via an operator control unit (18) and a first signal (7), containing the stop request and information concerning the identity of the request stop (1), is generated; said first signal (7) is transmitted by a send module to at least one central server (4); the central server (4) determines which bus (2) can reach the request stop (1) first for the desired time and the stop request is transmitted to said bus (2) by sending a second signal (8) to said bus (2), the driver being alerted to the signal via a signalling device.

The invention relates to a signaling method, in particular for signaling a stop request at a request stop of a transport company route, preferably a bus transport company, with the request stop only being approached if a passenger wishes to board or alight.

Many regional transport routes are characterized in that by means of so-called detours, i.e. the deviation in the routing of the main route, the catchment quality is improved, but that at the same time the attractiveness is decreased for a plurality of the passengers as a result of the increase in the travel time.

Solutions have been proposed in order to prevent this problem in which a stop is only approached when there is an actual need to do so. These known solutions usually entail an additional need for extra staff.

It is the object of the present invention to provide a method of the kind mentioned above which eliminates this problem and allows performing the signaling method without or with minimal additional staff.

This is achieved in accordance with the invention that the stop request is entered via an operator unit and a first signal is generated which contains the stop request and information on the identity of the request stop, that said first signal is transmitted by a send module to at least one central server, that the central server determines the bus which is able to best approach the request stop at the desired time and sends the stop request to the bus in such a way that it sends to said bus a second signal which is signalized to the bus driver via a signaling device.

The network load is minimized due to the fact that the stop request is sent to a central server and not to all possible buses. The server merely seeks a possible bus and sends the stop request only to this bus. As a result of the fact that the stop request is processed in the central server in computer manner, there is an additional possibility of simple logging and subsequent evaluation of the stop requests. The computer-controlled processing of the stop requests allows keeping the number of staff at a low level.

In a further embodiment of the invention it can be provided that the transmission of the first and/or second signal occurs through a mobile radiotelephony protocol, especially via GSM or GPRS or UMTS. By using the existing widely available mobile radiotelephony networks it is not necessary to set any special infrastructural measures. The standard GPRS allows establishing a permanent network connection between the request stop, the central server and the bus.

According to another variant of the invention it can be provided that the stop request is entered via an operator unit integrated in the request stop. The passenger thus does not require any separate device in order to connect to the central server.

In a further embodiment of the invention it can be provided that the determination of the bus by the central server occurs automatically. The necessary need for staff can thus be reduced to virtually zero. As a result of the automatic allocation by the server, the duration necessary for the allocation is further reduced in comparison with manual allocation.

In accordance with a further variant of the invention it can be provided that the central server determines the bus from the position of the request stop and the timetable data, such that it is checked which bus could approach the request stop best at the desired time according to the timetable. This represents an especially simple method for the automatic allocation of the buses to the stop requests.

In a further embodiment of the invention it can be provided that the central server determines the bus from the position of the request stop and the current coordinates of all or several buses, such that the coordinates of all buses which could best approach the request stop at the desired time are queried especially via GPS, and it is checked which bus could best approach the request stop at the desired time. This method allows taking into account temporary disturbances in the progress of the timetable in the allocation of the buses to the stop requests. Moreover, the passenger can be informed more precisely about the expected time of arrival.

In another embodiment of the invention it can be provided that the bus driver confirms the receipt of the stop request and the confirmation is forwarded to the central server. Communication with the bus driver can thus be logged more precisely. This also leads to the possibility, depending on the confirmation of the bus driver or in the case of the omission of such a confirmation, to take certain actions. For example, the stop request can be forwarded by the central server to the next possible bus driver in the case of a missing confirmation by a bus driver.

It can be provided for in a further embodiment of the invention that the confirmation, preferably with the expected arrival time of the bus or the still remaining waiting time, is forwarded to the operator unit and is displayed there. The passenger can thus be informed whether and at which time the next bus will approach the request stop.

The invention further relates to a request stop for marking the stop positions of a transport business.

Known request stops cannot be used for transmitting a stop request to a central office. This disadvantage is to be remedied by the present invention.

This is achieved in accordance with the invention that a power supply, an operator unit for entering a stop request and a send module for transmitting the stop request to a central server are provided. In this way it is possible to forward a stop request entered via an operator unit and sent via the send module to the central server that can be processed there.

It may be provided for in a further embodiment of the invention that the operator unit is queried by a computer provided in the request stop, which computer triggers the send module. The control by a computer offers a more flexible use of the request stop. In particular, the upload of new software into the computer allows implementing new functions in the request stop.

In a further embodiment of the invention it can be provided that in addition a receiver module and an indicator module preferably arranged as a display are provided. This allows providing the passenger with information about the stop request and additional information about the arrival times for example.

According to another embodiment of the invention it can be provided that the power supply comprises a solar panel. The request stop can thus be operated independent of an external power supply.

In a further embodiment of the invention it can be provided that the power supply comprises a storage battery and a charge controller for the storage battery. This allows storing the energy for the time sections where the power supply via the solar panel is insufficient due to lack of sunlight.

In a further embodiment of the invention it can be provided that the send module and/or the receiver module comprises a GSM modem and a GSM antenna. This allows making use of the existing infrastructure.

According to another embodiment of the invention it possible to provide a motion detector which is connected with the display module, especially via the computer. This allows reducing the power consumed by the display module.

The invention further relates to a data acquisition device, comprising a power supply, a measuring device, a send module for transmitting measured data to a central server, with the measuring device being queried by a computer which is provided in the data acquisition device and which triggers the send module.

Known data acquisition devices come with the disadvantage that they cannot be used independent from any external power supply.

It is the object of the present invention to remedy this disadvantage.

This is achieved in accordance with the invention that the power supply comprises a solar power unit, especially a solar panel. A power supply is thus obtained which is independent of mains supply.

In a further embodiment of the invention it can be provided that the power supply comprises a storage battery and a charge controller for the storage battery. An energy storage unit is thus obtained for days with insufficient insolation.

In accordance with another embodiment of the invention it can be provided that additionally a receiver module and a display module are provided. This allows sending data back to the data acquisition device and outputting them there.

It can be provided for in a further development of the invention that the send module and/or the receiver module comprises a GSM modem and a GSM antenna. This allows making use of the existing network infrastructure.

In a further embodiment of the invention a motion detector can be provided which is connected with the display module, especially via the computer. It allows minimizing the power consumption of the display module, such that it is only supplied when a person is located close to the data acquisition device.

Finally, the invention relates to a transport system for a transport business, especially a bus transport business, comprising at least one request stop which is only approached when a passenger desires to alight or board, at least one central server and at least one signaling device in a vehicle or bus of the transport business.

Known transport systems are not suitable for the automatic transmission of a stop request to a bus. It is the object of the present invention to remedy this disadvantage.

This is achieved in accordance with the invention in that the request stop comprises an operator unit for entering a stop request and a send module for transmitting the stop request to the central server, that the central server 4 comprises a communication module for data exchange with the request stop 1 and the signaling device. Stop requests can thus automatically be sent from the request stop to the central server and from the same to the bus in question.

In a further embodiment of the invention it can be provided that the signaling device is realized by a mobile phone programmed in Java. This allows using conventional devices as a signaling device. The special functionality of the signaling device can be programmed via the platform-independent language Java. The use of Java allows the best possible portability of the software code to other devices or mobile phones.

The invention is now described in closer detail by reference to the enclosed drawings showing especially preferred embodiments, wherein:

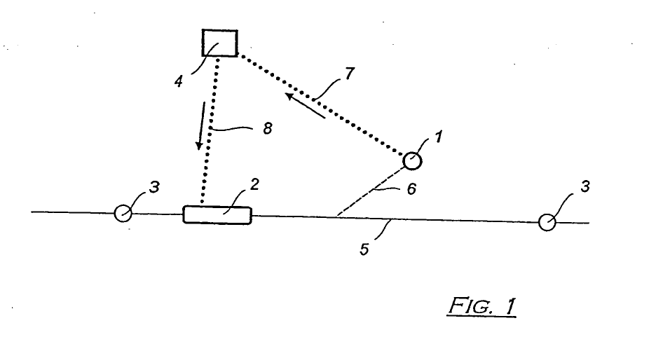

FIG. 1 shows a schematic diagram of the signaling method in accordance with the invention;

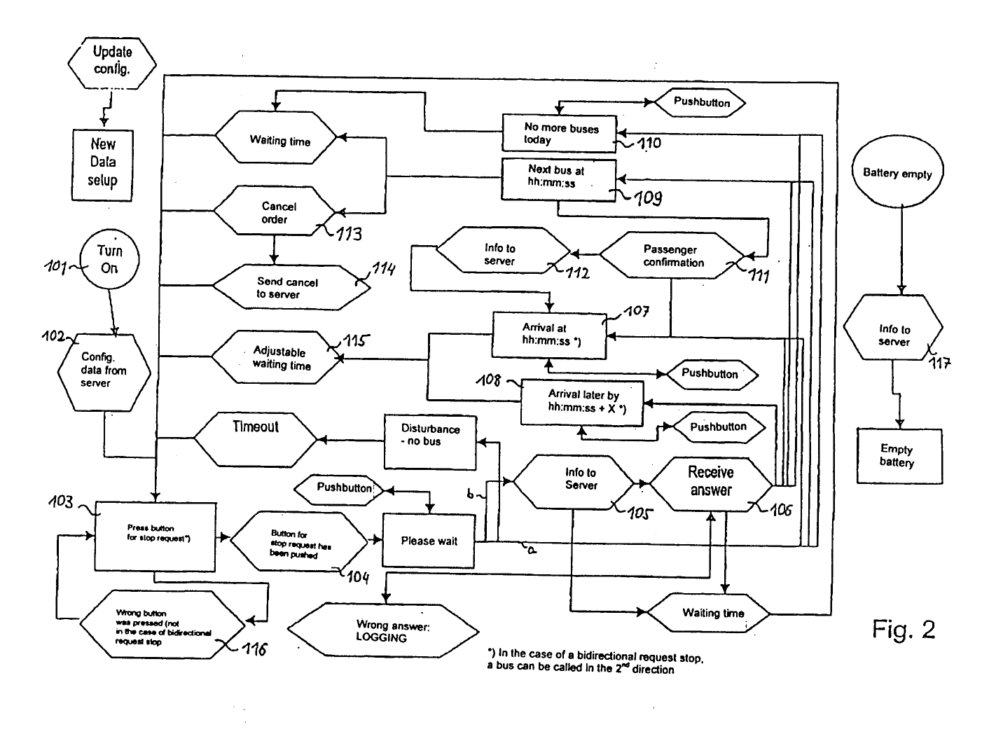

FIG. 2 shows a flow chart of the software in request stop 1;

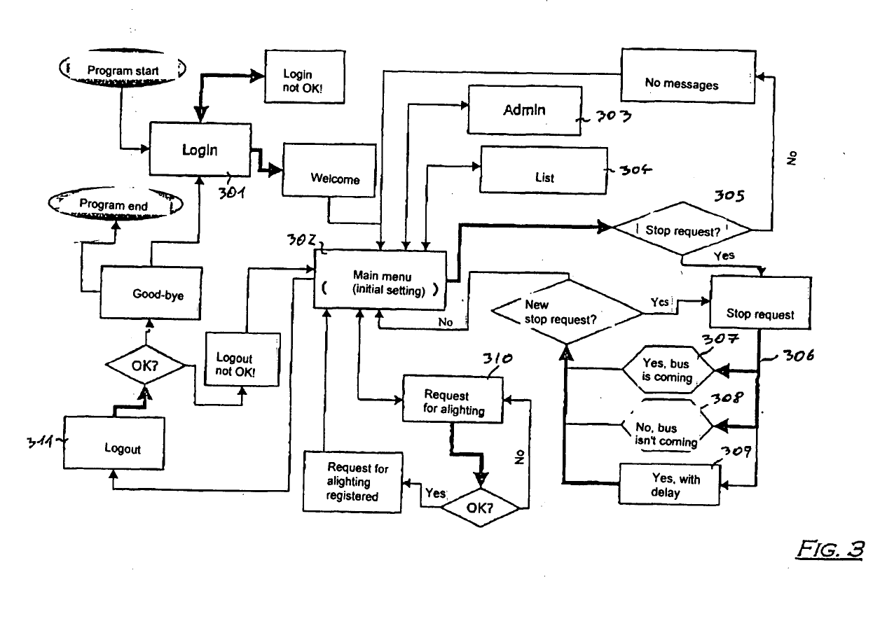

FIG. 3 shows a flow chart of the software in the signaling device 19 of the bus;

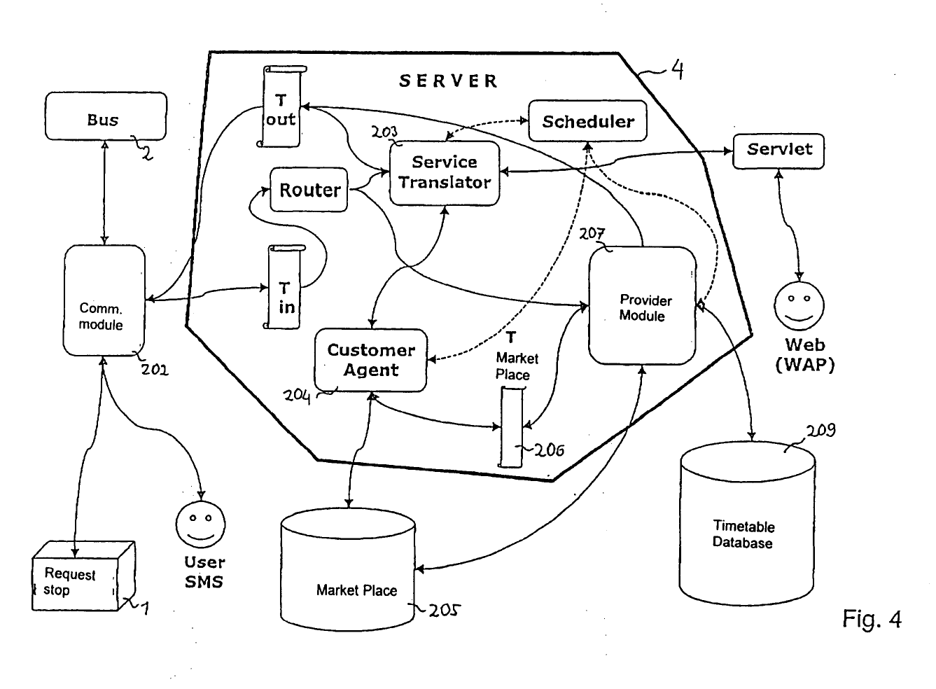

FIG. 4 shows a structured chart of the communication flows between request stop 1, central server 4 and bus 2;

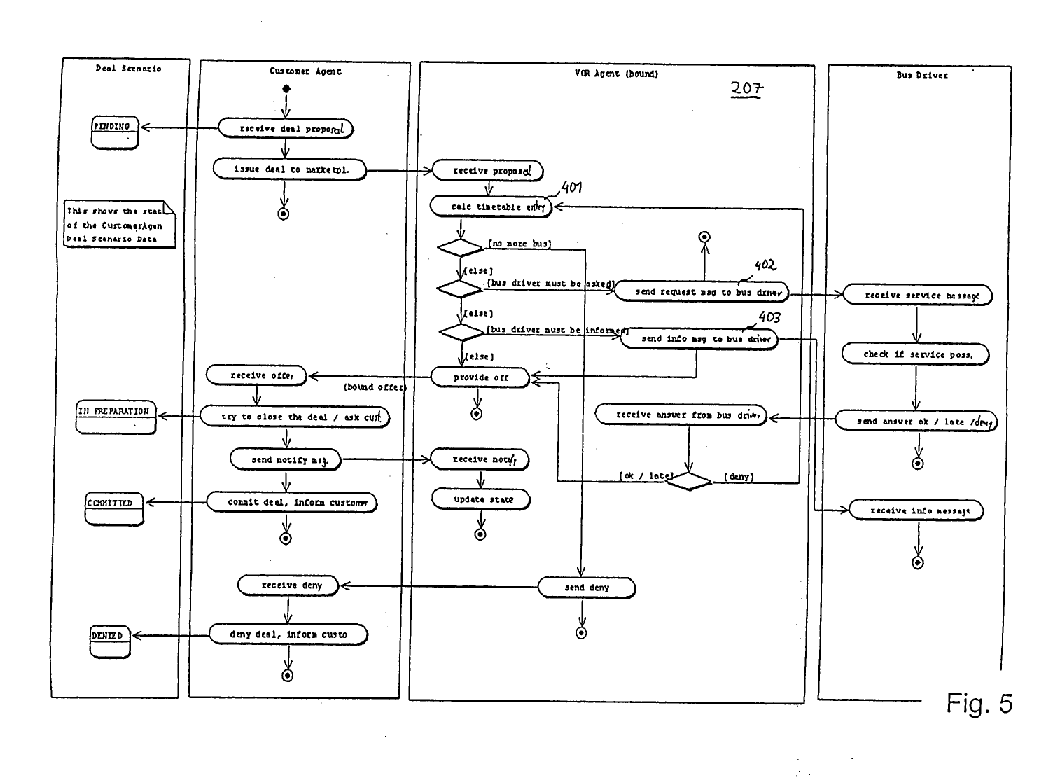

FIG. 5 shows a time flow chart of the communication flows between request stop 1, central server 4 and bus 2;

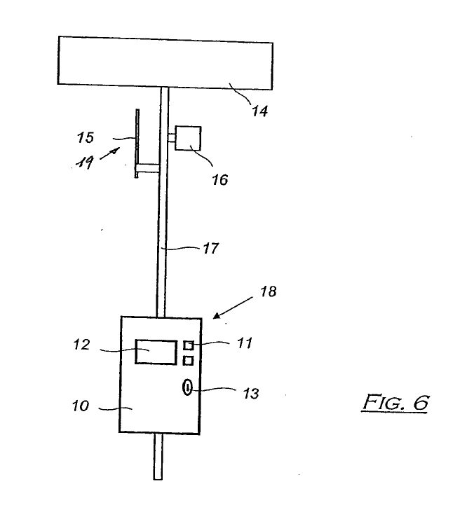

FIG. 6 shows a request stop 1 in an overall view;

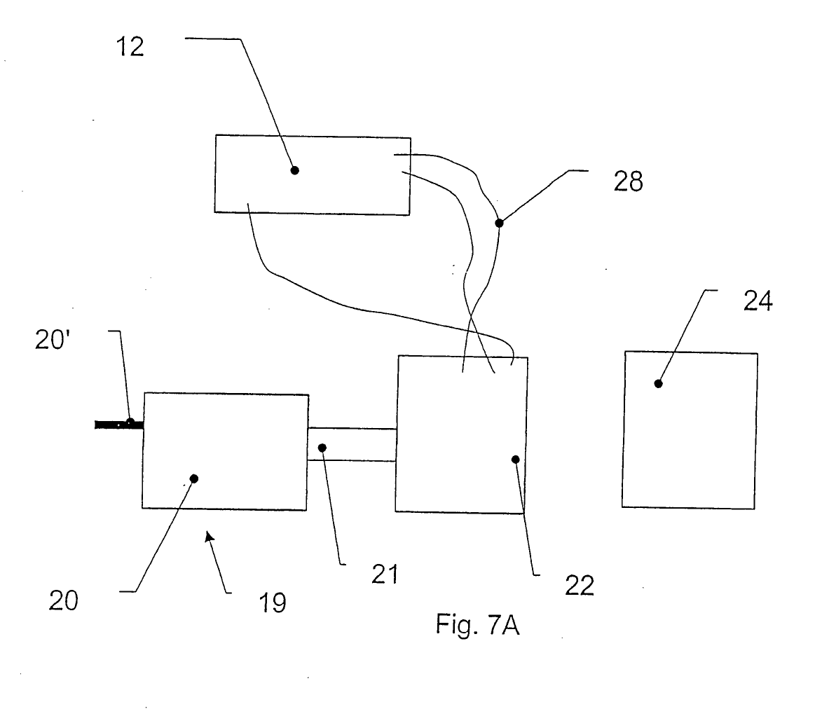

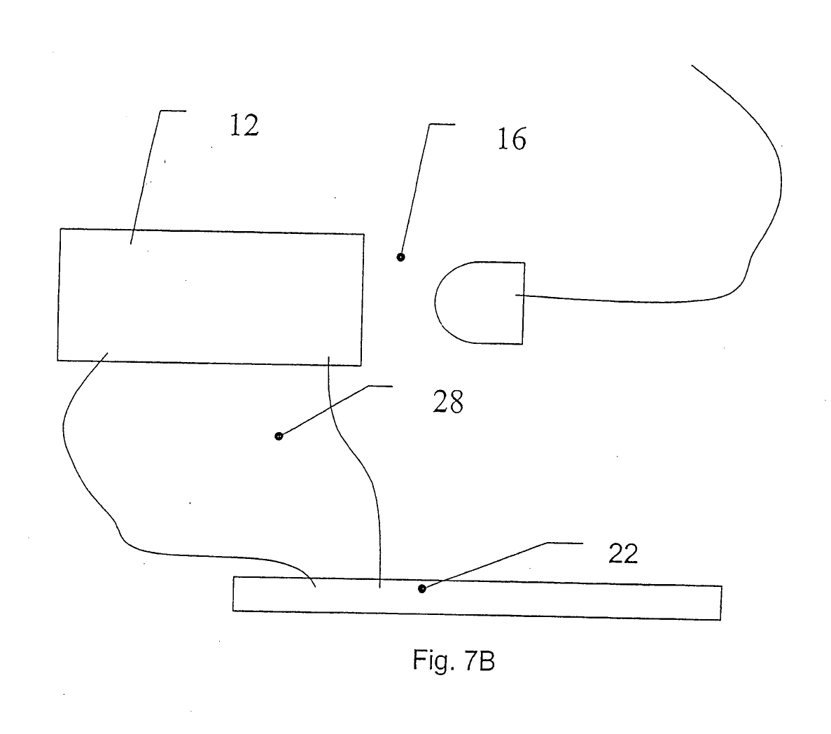

FIG. 7a shows the electronic components of the request stop 1 in accordance with the invention in FIG. 6;

FIG. 7b shows a view of the display 11 and the motion detector 16, and

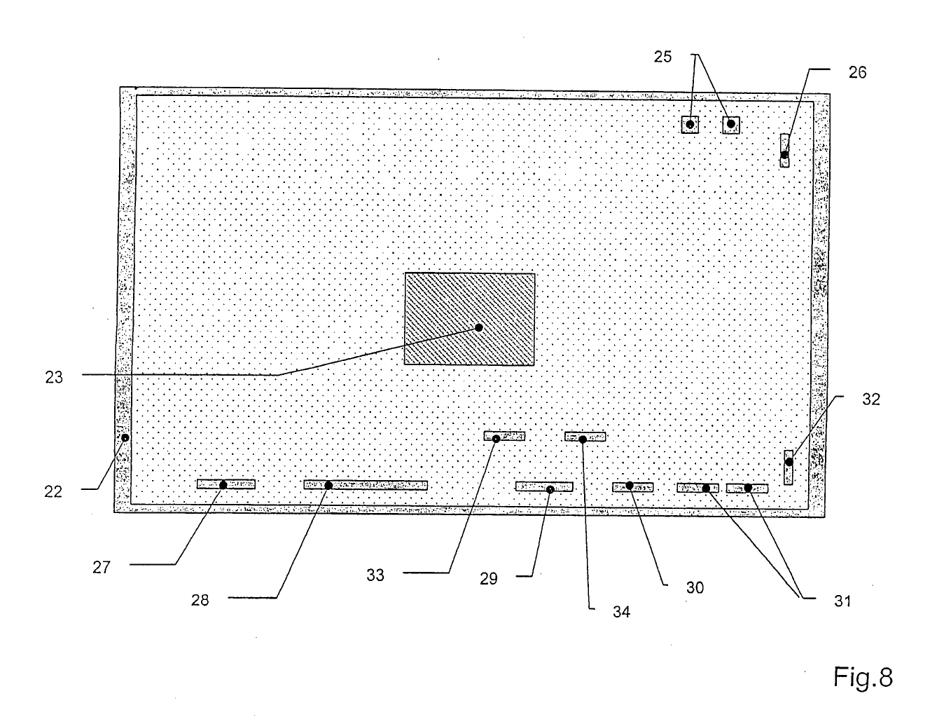

FIG. 8 shows the circuit board 22 of a request stop 1 in accordance with the invention 1.

FIG. 1 shows a route 5 with several stops 3 and a request stop 1 which can be reached via a route section 6. Request stop 1 shall only be approached by bus 2 if a passenger of bus 2 wishes to alight at said request stop 1 or if a passenger wishes to board the bus 2 at the request stop 1. The passenger can inform the bus driver directly in the first case.

The method in accordance with the invention provides in the second case that the passenger sends a first signal 7 to a central server 4 and that said central server 4 forwards the stop request to the bus 2, whereupon the bus driver approaches the request stop 1.

In contrast to other systems such as collective taxis, the proposed system concerns an urban coach system with a precisely defined sequence of stops 3, with the request stop 1 only be approached when necessary.

The stop request can be sent by the passenger to the central server in many different ways. Preferably, the transmission occurs via mobile radiotelephony. The passenger can send the stop request to the central server 4 via SMS by stating the stop number corresponding to the request stop 1.

Another advantageous possibility is that the passenger activates an operator unit 18, especially a key button 11, directly at the request stop 1 and the stop request is sent from the request stop 1 to the central server 4 via GPRS for example. In this case, the information about the geographical position of the request stop 1 (e.g. via a unique stop number) is automatically co-transmitted to the central server 4. The position of the request stop 1 is encoded preferably via a unique stop number which is allocated to each stop 3 or request stop 1. The relevant aspect is that a unique identification of the request stop 1 is enabled.

It is obvious that also a conventional radio network or even transmission via cable can be used in order to send the stop request to the central server 4. The use of GSM network offers the advantage of an already existing widely available network. Moreover, the distribution of the load among several central servers 4 is possible.

The central server 4 determines the bus 2 which can best approach the request stop 1 at the desired time from the stop number or from the data on the position of the request stop 1 and the desired time.

The desired time is the time of issuing the stop request for example. It is also possible that a passenger sends his stop request one day previously by SMS or chooses a later desired time for the stop.

Preferably, the bus 2 in question will be determined by the server 4 automatically. This occurs most simply by automatic reconciliation with the timetable data. The central server 4 checks which bus could approach the request stop 1 according to timetable in the best manner at the desired time. Thereafter the stop request is forwarded by the central server 4 to the bus 2, whereupon the bus driver approaches the request stop 1.

Since the buses 2 will not operate precisely according to timetable due to the flexible system of the request stop 1, the possibility of a precise alignment with the actual position of the buses is advantageously possible. In this case, the current positional data are queried in each bus 2 continually via GPS and sent by SMS or GPRS to the central server 4. The choice of the bus 2 closest to the request stop 1 is then made by means of adjustment with the actual position of the buses 2.

The relevant feature of the presented solution is that the communication processes and the choice of the buses 2 can be processed without any additional need for staff.

After the transmission of the stop request to the respective bus 2, the bus driver can confirm the receipt. This confirmation is then forwarded to the central server 4 and from there to the passenger. Additional information can be co-transmitted such as the remaining waiting time.

FIG. 2 shows a flow chart concerning the interaction of the passenger with the operator unit 18 of the request stop 1. During the first-time activation or when the request stop 1 is activated, the configuration data are queried from the central server in the steps 101 and 102 and transmitted to the memory of the request stop 1. Usually, the passenger is offered in 103 a short welcome text or brief information. When the passenger presses the key button 11 in 104, in the regular case b the information on the stop request is sent to the server in step 105 and the response of the server is waited for in 106. Depending on the response of the central server 4, the passenger is shown the expected arrival time in 107, 108 or 109. Alternatively, it is displayed in 110 that a bus can no longer approach the request stop 1 on the respective day. Item 109 is run through if the earliest bus 2 can only arrive after a considerable waiting period, whereupon the passenger must confirm in 111 that he or she actually wishes to order the bus. This confirmation is forwarded in 112 to the central server. Otherwise, only the expected arrival time is displayed in 107 and 108 because the bus has already been requested by the server. After an adjustable waiting time in 115 according to which the bus has already reached the request stop 1 in the usual case, the system will revert to its original state 103.

In order to minimize network traffic in the mobile radiotelephony network it can be provided that the timetable of the respective bus line is stored in a computer unit 23 or in the memory of the request stop 1. In this case the next bus in question can be determined directly by the request stop 1. After pressing the key button 11 by passenger in 104, the next bus is indicated in 109 via route a or a message is displayed in 111 that bus service is no longer available on this day. The passenger can confirm via 111 again that he or she wishes to order this bus or can cancel the order in 113, which information is sent to the central server 4 in 114.

In some request stops 1, e.g. stops for several buses, it is possible to enter queries for different bus lines or for different traveling directions of the same bus line. Several key buttons 11 can be provided for this purpose. The question whether a correct key button 11 was pressed by a passenger is queried in 116. It will only be treated further if the entry was made correctly.

In addition to the sequence as described above, special messages such as the message on a low charging state of the battery of request stop 1 can be sent to the central server 4.

FIG. 3 shows the sequence of the interaction of the bus driver with the signaling device 40 in the bus 2. It consists for example of a conventional mobile phone with a Java programming environment. The fat arrows symbolize the flow steps where a data transmission occurs between the signaling device 40 and the central server 4.

After the start of the program, the bus driver is asked in 301 to log into the system. Once the login has been successfully completed, the main menu of the application appears in 302 after a short welcome message. The bus driver can use this main menu to make certain settings by choosing the menu item in 303 or to have the current list of request stops 1 to be approached displayed in 304.

Once a stop request for a certain request stop 1 has been received by the central server 4 and the central server 4 has chosen this bus 2, the driver will be notified by an acoustic signal. The driver then requests the new stop request(s) from the central server 4. The new stop request(s) are processed in a loop. The driver can state for each stop request in 307, 308 or 309 whether or not he or she is able to approach the respective request stop 1 or with which delay. These answers of the bus driver are sent to the server 4. Once all stop requests have been processed, the system reverts to the initial position 302.

Passenger requests for alighting from the bus can be sent to the central server 4 additionally in 310. If the bus driver needs to approach a request stop 1 because a passenger wishes to leave the bus 2 there, then the central server 4 will be informed accordingly. This can be used to fine-tune the timetable or also for displaying at the request stop 1 that the next bus 2 will arrive shortly.

At the end of his shift, the bus driver can log out of the system via a menu item in 311.

FIG. 4 explains the architecture of the central server 4 and the connections between the central server 4, the bus 2 and the request stop 1. Communication occurs via a communication module 202 which can exchange data via GPRS with the signaling device 40 in bus 2 and the request stop 1. Moreover, SMS sent by the passenger are sent first to the communication module 202. This communication module 202 communicates with the central server 4 via a defined protocol, e.g. XML, with the incoming and outgoing messages in 203 being translated into a format used by the server. In addition, queries can also be entered in a different manner, e.g. via a web interface and a Java Servlet 208, and be forwarded to the central server 4.

Incoming queries are checked at first for permissibility in 104 by matching with a user database 205 and are saved in a list of current queries. This list of current queries is designated as market place 205. The market place 205 is preferably with JMS (Java Messaging Service). The architecture of the central server 4 is kept open and provides that several transport businesses or several providers can access said market place 205 through provider modules 207 In the simplest of cases of a single provider, the provider module 207 reads out the query or the stop request from the market place 205 and determines bus 2 in question for the stop request at the request stop 1 by matching the data with a timetable database 209.

FIG. 5 outlines the communication flow between the individual modules of the central server 4 and the bus 2. The determination of the next bus 2 occurs in the central server 4 at the level of the provider module 207 in item 401. Timetable database 209 preferably contains all possible stop times of the individual buses 2 at all request stops 1. The next bus 2 is determined, by comparison with the desired stop time from said database. If the time interval between the notification of the bus driver and the desired stop time is very short it may occur that the bus driver can no longer approach the station because the respective motorway exit has already been passed. In these close cases it is necessary to ask the bus driver in item 402 whether they are still capable of reaching the request stop 1. If the planned arrival time can securely be reached, it is merely necessary to notify the bus driver in 403, whereupon the same must approach the request stop 1.

The request stop 1, the central server 4 and the signaling device 40 in the bus 2 thus form a transport system which is used for the signaling method in accordance with the invention.

An advantageous embodiment of a request stop 1 for performing the method in accordance with the invention is discussed below by reference to a concrete example.

The request stop 1 as shown in FIG. 6 comprises an operator unit 18 which comprises a key button 11 and an indicator module configured as a display 12. Suitable key buttons 11 are keypads, door-openers with a large illuminated key field without any moving parts, or pushbuttons such as the Omron pushbutton A22 IP65. the size and number of pushbuttons 11 must be adjusted to the operating logic and the display size. If options are written into different lines, the pushbutton diameter is preferably not substantially larger than the height of a line. As a result of the favorable arrangement possibilities, small pushbuttons 11 are used in FIG. 6 which can be mounted to the right of the display 12. The illustrated pushbuttons are made of metal and are thus protected against vandalism. The pushbuttons have separately controllable LEDs for energy-saving reasons. In addition to the described pushbuttons 11, it is also possible to provide other operator units 18 such as sensors for voice input by means of which the passenger can signalize his or her stop request.

Especially high demands are placed on the display 12 with respect to readability, costs, power consumption and contrast control. Different graphic displays or alphanumeric displays can be used. The illustrated display 12 is a text display with LED background illumination. The setting of the contrast preferably occurs depending on the outside temperature. A separate circuit is used in this case for the temperature-dependent contrast control.

As a result of the power consumption, the illumination duration of the display 12 is preferably kept as short as possible. For this reason the request stop 1 comprises a motion detector 16 which is mounted on a mast 17, which detector is connected with the indicator module or the display 12 via the computer unit 23. The motion detector detects persons which are close to the stop. As a result of the motion detector 16, the screen on the display 12 will only be activated when a passenger enters the area of the request stop 1. A motion detector 16 for external erection is preferably chosen which has a low basic power consumption.

A light-sensitive element is further provided in the motion detector 16 in order to measure the ambient brightness and to decide whether the LCD display 12 needs to be illuminated. By setting to night-time operation the likelihood of erroneous initiation by reflected sunlight is not relevant.

The electronic components are housed in FIG. 6 in a cabinet 10 which can be locked with a lock 13. The cabinet 10 is used to protect the electronic system from weather influences. This cabinet 10 is mounted on a mast 17 on which a GSM antenna 15 is also attached. Power and signal lines are guided in the mast 17.

The communication unit 19 of the request stop 1 comprises a GSM modem 20 and a GSM antenna 15. The antenna 15 is used for establishing the radio connection between the communication unit 19 of the request stop 1 and a base station of the mobile radiotelephony operator. A simple rod antenna is preferably used as a result of the possible local implementation of base stations. The GSM antenna 15 is mounted in the upper region of the mast 17 in order to obtain a favorable radiation behavior and to avoid exposing the passenger to excessive radiation loads. The limit values for high-frequency field exposition are determined by ICNIRP (International Commission on Non-Ionizing Radiation Protection) and are used by the WHO and most governments. The limit value as recommended by ICNIRP is close to 5000 mW/m2 for 1000 MHz (GSM 900) and 9000 mW/m2 for 1800 MHz. For the purpose of adhering to these limit values (ICNIRP), a remote GSM antenna 15 in a height of approximately 3 m is used.

The request stop 1 further comprises a solar panel 14 which is also mounted on the mast 17. The solar panel 14 is a part of the power supply of BH 1 and allows erecting the request stop 1 irrespective of an external power supply.

The solar panel 14 supplies a storage battery via a charge controller. The solar panel 14 is preferably mounted in such a way that a passage height of approximately 2.4 m is guaranteed. When mounted it will be fastened in a twist-proof way so that an optimal illumination or insolation is ensured.

Amorphous modules are preferably chosen for the solar panel 14. As a result of the slightly higher voltages of the amorphous modules, the charge controller is provided with a higher voltage.

A charge controller is preferably interposed between the solar panel 14 and the storage battery. This charge controller ensures that charging is performed in such a way that the storage battery is not damaged. Moreover, the charge controller checks the discharge depth of the storage battery.

The storage battery is the energy storage means interposed between charge controller and consumer which allows bridging the night and periods of low insolation. Depending on the storage battery's form factor, other housings are required. The electronic system is preferably arranged separately and the battery compartment is vented in the case of gassing of the storage battery.

The structure of the electronic components of a request stop 1 in accordance with the invention is explained below based on a concrete embodiment. The invention is not limited to the shown components.

FIG. 7a shows on the left the GSM modem 20, which in this case is a Motorola g18 with the mmex-FME antenna adapter 20′ facing to the left. The modem 20 is connected via a laminated ribbon cable 22 with a miniature socket of the circuit board 22 and further with the power supply and the computer 23. The modem 20 and the communication unit is used for bidirectional transmission of the information between the request stop 1 and the central server.

The upper side of FIG. 7a shows the display 12 which in this case is a Batron 42008, which display is connected with the circuit board 22 via a data line 28 and a separate cable for the power supply for the background illumination. The cover 24 for screening the computer 23 is also shown.

FIG. 7b shows the display 12 from the front and the opened 12 V infrared motion detector 16.

FIG. 8 shows the circuit board 22 with the attached onboard computer 23 which has its own processor, memory and the necessary I/O ports. The circuit board 22 is connected with the supply voltage via the connectors 25. The display 12 is connected with the circuit board 22 via a data line 28 and a separate cable 26 for the power supply for the background illumination.

The software for operating the request stop 1 can be uploaded onto the computer via the ribbon cable 29. It can be determined through a first jumper 33 whether the data are written into volatile or non-volatile memory of the computer 23.

The two pushbuttons 11 are connected with the circuit board 22 via the lines 31.

An NTC temperature sensor is connected via conductor 32 to circuit board 22 for controlling the contrast of the display 12 which needs to be controlled depending on the outside temperature.

A further jumper 34 can be provided through which a so-called watchdog can be activated which resets the circuit board to the initial state in regular intervals.

The computer 23 comprises the logic circuit for the communication with the user via the pushbutton 11 and the display 12 and the communication based on this with the central server 4 via the GSM modem 20.

It is obvious that additional functions are possible. For example, the computer 23 can be used to detect different measured values or data. In the illustrated embodiment, only a motion detector 16 is connected. It is possible however that different data such as the different measured values of a weather station are detected by the computer 23 and are forwarded to the central server 4.

Preferably, the computer offers further options such as the reloading of code during operation, an internal clock, Java support, publicly available libraries for the periphery low level classes for RS-232, I/O ports, sensor systems and communication (TCP/IP PPP point to point protocol).

It is naturally also possible not to provide any separate processor and to use the processor of the GSM modem 20 for control purposes. In this case said processor acts as a computer 23. It is further possible to use microprocessors μPs, single board computers such as the described JSTAMP or native Java processors. It is analogously also possible to use a μC or a GSM module with built-in 64 kB flash RAM and TCP/IP stack (e.g. the μWEB GSM 10).

As already mentioned, the presented request stop 1 can also be used to detect a large variety of measured values or data and to forward the same to a central server 4. In this general context, the motion sensor, temperature sensor and pushbutton 11 represent in this connection a different measuring device 18 which is queried by the computer 23. These data are forwarded to the central server 4. The power supply by means of solar panel 14 allows using the data acquisition device independent of any external power supply.

1. Signaling method, in particular for signaling a stop request at a request stop (1) of a transport company route, preferably a bus transport company, with the request stop (1) only being approached if a passenger wishes to board or alight, characterized in that the stop request is entered via an operator unit (18) and a first signal (7) is generated which contains the stop request and information on the identity of the request stop (1), that said first signal (7) is transmitted by a send module (19) to at least one central server (4), that the central server (4) determines the bus (2) which is able to best approach the request stop (1) at the desired time and sends the stop request to the bus (2) in such a way that it sends to said bus a second signal (8) which is signalized to the bus driver via a signaling device (40).

2. Method as claimed in claim 1, characterized in that the transmission of the first and/or second signal occurs through a mobile radiotelephony protocol, especially via GSM or GPRS or UMTS.

3. Method as claimed in claim 1, characterized in that the stop request is entered via an operator unit (18) integrated in the request stop (1).

4. Method as claimed in claim 1, characterized in that the determination of the bus (2) by the central server (4) occurs automatically.

5. Method as claimed in claim 1, characterized in that the central server (4) determines the bus (2) from the position of the request stop (1) and the timetable data, such that it is checked which bus (2) could approach the request stop (1) best at the desired time according to the timetable.

6. Method as claimed in claim 1, characterized in that the central server (4) determines the bus from the position of the request stop (1) and the current coordinates of all or several buses (2), such that the coordinates of all buses (2) which could best approach the request stop (1) at the desired time are queried especially via GPS, and it is checked which bus (2) could best approach the request stop (1) at the desired time.

7. Method as claimed in claim 1, characterized in that the bus driver confirms the receipt of the stop request and the confirmation is forwarded to the central server (4).

8. Method as claimed in claim 1, characterized in that the confirmation, preferably with the expected arrival time of the bus (2) or the still remaining waiting time, is forwarded to the operator unit (18) and is displayed there.

9. Request stop (1) for marking the stop position of a transport business, characterized by a power supply, an operator unit (18) for entering a stop request and a send module (19) for transmitting the stop request to a central server (4).

10. Request stop (1) as claimed in claim 9, characterized in that the operator unit (18) is queried by a computer (23) provided in the request stop (1), which computer triggers the send module (19).

11. Request stop as claimed in claim 9, characterized in that in addition a receiver module (41) and an indicator module preferably arranged as a display (12) are provided.

12. Request stop as claimed claim 9, characterized in that the power supply comprises a solar panel (14).

13. Request stop as claimed claim 9, characterized in that the power supply comprises a storage battery and a charge controller for the storage battery.

14. Request stop as claimed in claim 9, characterized in that the send module (19) and/or the receiver module (41) comprises a GSM modem (20) and a GSM antenna (15).

15. Request stop as claimed in claim 9, characterized by a motion detector (16) which is connected with the display module, especially via the computer (23).

16. Data acquisition device, comprising a power supply, a measuring device (18), a send module (19) for transmitting measured data to a central server (4), with the measuring device (18) being queried by a computer (23) which is provided in the data acquisition device (1) and which triggers the send module (19), characterized in that the power supply comprises a solar power unit, especially a solar panel (14).

17. Data acquisition device as claimed in claim 16, characterized in that the power supply comprises a storage battery and a charge controller for the storage battery.

18. Data acquisition device as claimed in claim 16, characterized in that additionally a receiver module (20) and a display module (12) are provided.

19. Data acquisition device as claimed in claim 16, characterized in that the send module (19) and/or the receiver module (41) comprises a GSM modem (20) and a GSM antenna (15).

20. Data acquisition device as claimed in claim 16, characterized by a motion detector (16) which is connected with the display module (12), especially via the computer (23).

21. Transport system for a transport business, especially a bus transport business, comprising at least one request stop (1) which is only approached when a passenger desires to alight or board, at least one central server (4) and at least one signaling device (40) in a vehicle or bus (2) of the transport business, characterized in that the request stop (1) comprises an operator unit (18) for entering a stop request and a send module (19) for transmitting the stop request to the central server (4), that the central server (4) comprises a communication module for data exchange with the request stop (1) and the signaling device (40).

22. Transport system as claimed in claim 21, characterized in that the signaling device (40) is realized by a Java-programmed mobile phone.
